(19) United States
(12) Patent Application Publication
(10) Pub. No.: US 2025/0130612 A1
(43) Pub. Date: Apr. 24, 2025

(54) FOLDABLE DISPLAY DEVICE

(71) Applicant: Wuhan China Star Optoelectronics Semiconductor Display Technology Co., Ltd., Wuhan (CN)

(72) Inventor: Huan CAO, Wuhan (CN)

(21) Appl. No.: 17/785,067

(22) PCT Filed: May 20, 2022
(86) PCT No.: PCT/CN2022/094054

§ 371 Date: Jan. 8, 2025

(30) Foreign Application Priority Data
May 12, 2022 (CN) 202210520659.4

(51) Int. Cl. G06F 1/16

(52) U.S. Cl. CPC G06F 1/1681; G06F 1/1616; G06F 1/1652

(57) ABSTRACT

The present disclosure provides a foldable display device. The foldable display device includes at least two hinge sub-assemblies, and each hinge sub-assembly includes a first guide component, a second guide component, a first transmission component disposed with a first slide rail sub-assembly, and a second transmission component disposed with a second slide rail sub-assembly; the first transmission component is rotatably connected with a first shell, and the second transmission component is rotatably connected with a second shell; and the above-mentioned foldable display device can realize seamless foldable in appearance.

### TECHNICAL FIELD

The present disclosure relates to a field of display, and particularly to a foldable display device.

### BACKGROUND

Foldable display devices are one of hotspots of future electronic products. At present, the foldable display devices have become a major development direction of the display industry. Mismatch between mechanism surfaces of foldable display devices before being folded or after being folded and a size of a flexible display screen of the foldable display devices is a major problem that urgently need to be solved for foldable display devices. Wherein a foldable display device usually requires a mechanism design that allows a mechanism to make room after bending to accommodate an extra flexible display screen relative to the mechanism.

However, when a current foldable display device realizes bending, multiple inward foldable mechanisms are required to realize the bending, which results in an excessively large occupied volume and is difficult for the multiple inward foldable mechanisms to simultaneously realize the bending, resulting in an uneven overall surface of the flexible display screen, making the inward foldable mechanisms unable to effectively fold a display screen, so that it is difficult to realize a seamless foldable of the foldable display device in appearance, which further reduces user experiences.

Therefore, there is an urgent need for a foldable display device to solve above technical problems.

### SUMMARY OF DISCLOSURE

### Technical Problem

It is difficult for an existing foldable display device to achieve seamless foldable in appearance of the foldable display device, which further reduces the user experiences.

### Solutions to the Technical Problem

### Technical Solutions

Embodiments of the present disclosure provide a foldable display device, wherein the foldable display device includes a shell body and a flexible display panel, the shell body includes a first shell, a second shell, and a bending assembly, the flexible display panel is disposed on one side of the first shell, the second shell, and the bending assembly;
the bending assembly is received in the shell body and connected to the first shell and the second shell; the bending assembly includes at least two hinge sub-assemblies, and each of the hinge sub-assemblies includes a synchronization mechanism, a first rotation mechanism, and a second rotation mechanism, the first rotation mechanism is fixedly connected with the first shell and arranged on one side of the synchronization mechanism, the first rotation mechanism is rotatably connected with the synchronization mechanism; the second rotation mechanism is fixedly connected with the second shell and arranged on another side of the synchronization mechanism away from the first rotation mechanism, the second rotation mechanism is rotatably connected with the synchronization mechanism;
the synchronization mechanism includes a first guide component disposed close to the first shell and a second guide component disposed close to the second shell; the first rotation m333333echanism includes a first transmission component, a first slide rail sub-component is disposed on one side of the first transmission component close to the synchronization mechanism, and one end of the first transmission component away from the synchronization mechanism is rotatably connected with the first shell; the second rotation mechanism includes a second transmission component, a second slide rail sub-component is disposed on one side of the second transmission component close to the synchronization mechanism, and one end of the second transmission component away from the synchronization mechanism is rotatably connected with the second shell;
wherein when the flexible display panel is in an explanate state, the first slide rail sub-component cooperates with the first guide component, and the second slide rail sub-component cooperates with the second guide component; and when the flexible display panel is in a bending state, the first slide rail sub-component is away from the first guide component, and the second slide rail sub-component is away from the second guide component.

### BENEFICIAL EFFECT OF THE DISCLOSURE

### Beneficial Effect

In the foldable display device of the present disclosure, the bending assembly is provided in the shell body, wherein the bending assembly includes at least two hinge sub-assemblies, each of the hinge sub-assemblies includes a synchronization mechanism, a first rotation mechanism, and a second rotation mechanism, the first rotation mechanism is rotatably connected with the synchronization mechanism, and the second rotation mechanism is rotatably connected with the synchronization mechanism, wherein when the flexible display panel is in an explanate state, the first slide rail sub-component cooperates with the first guide component, and the second slide rail sub-component cooperates with the second guide component; and when the flexible display panel is in a bending state, the first slide rail sub-component is away from the first guide component, and the second slide rail sub-component is away from the second guide component; so that when the flexible display panel changes between the explanate state and the bending state, the first transmission component and the second transmission component acts as both an angle guide mechanism for the flexible display panel and acts as an arc-shaped rotation mechanism, which can enhance stability of the hinge sub-assemblies. At the same time, the second rotation mechanism rotates synchronously with the first rotation mechanism through the synchronization mechanism, so that the foldable display device always maintains a symmetrical state during a bending process, furthermore, when the foldable display device is completely folded, the flexible portion of the flexible display panel is in a water drop-like folded state, which further realizes the seamless foldable of the foldable display device in appearance.

### BRIEF DESCRIPTION OF THE DRAWINGS

### Description of the Drawings

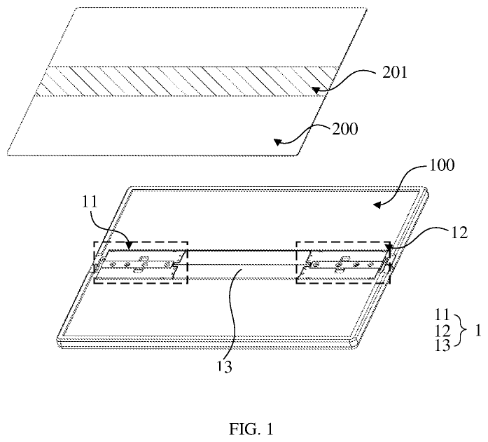

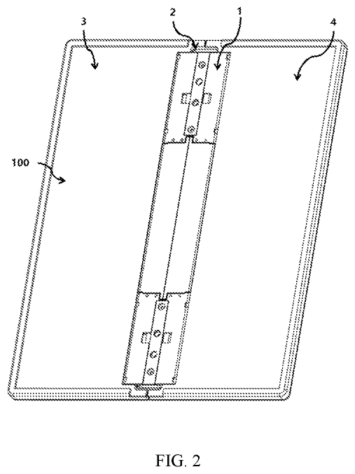

FIG. 1 is a schematic view of a relationship between a flexible display panel, a shell body, and a bending assembly in a foldable display device provided by an embodiment of the present disclosure.

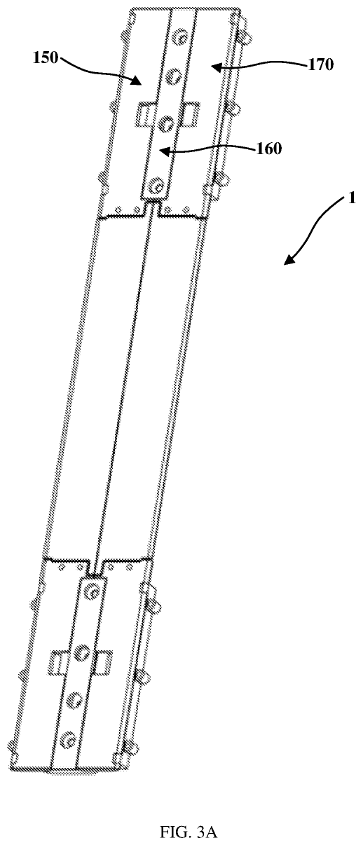

FIG. 2 is a schematic view of a relationship between the shell body and the bending assembly in the foldable display device provided by an embodiment of the present disclosure.

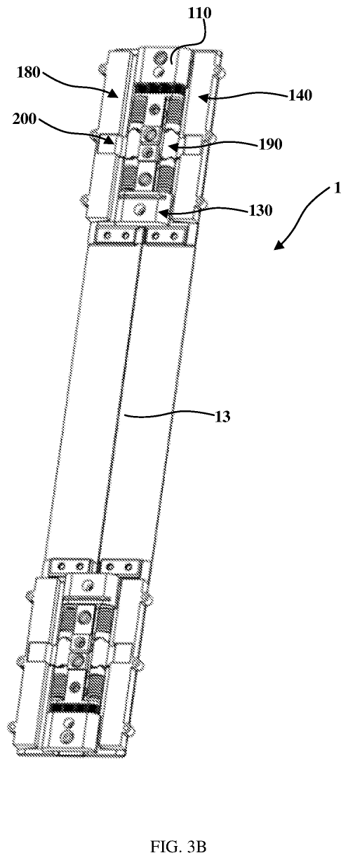

FIG. 3A is an axonometric view of a side of the bending assembly close to the flexible display panel when the foldable display device provided by an embodiment of the present disclosure is in an explanate state.

FIG. 3B is an axonometric view of a side of the bending assembly away from the flexible display panel when the foldable display device provided by an embodiment of the present disclosure is in the explanate state.

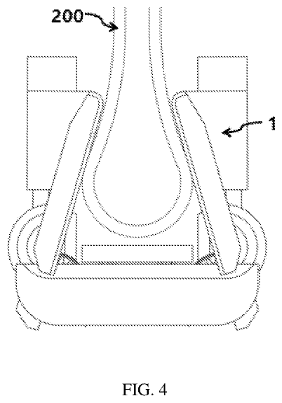

FIG. 4 is a schematic view of cooperation between the flexible display panel and the bending assembly in a fully folded state of the foldable display device provided by an embodiment of the present disclosure.

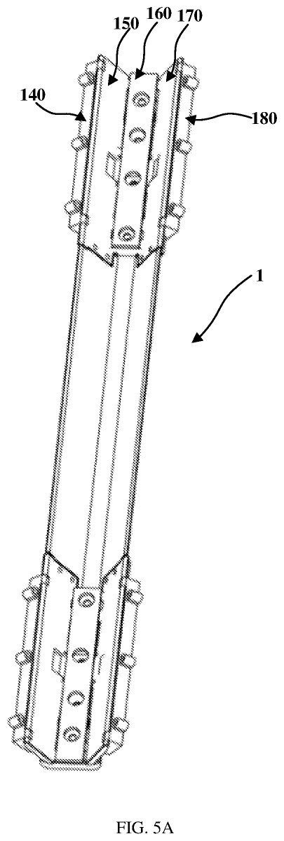

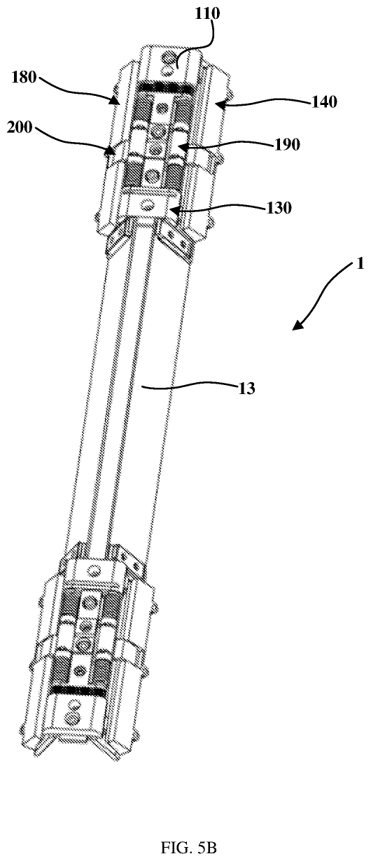

FIG. 5A is an axonometric view of the side of the bending assembly close to the flexible display panel when the foldable display device provided by an embodiment of the present disclosure is in a bending state.

FIG. 5B is an axonometric view of the side of the bending assembly away from the flexible display panel when the foldable display device provided by an embodiment of the present disclosure is in the bending state.

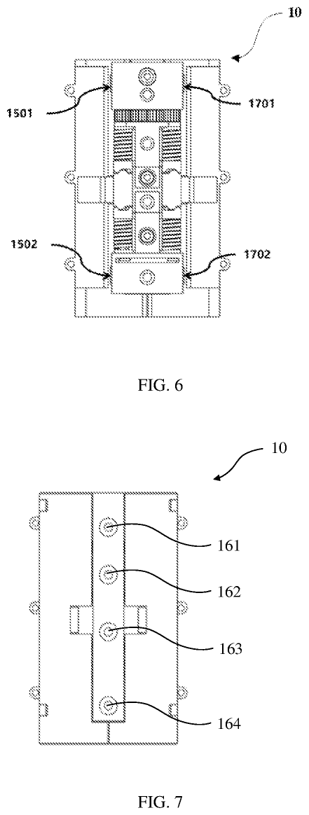

FIG. 6 is an axonometric view of a side of a hinge sub-assembly away from the flexible display panel when the foldable display device provided by an embodiment of the present disclosure is in the explanate state.

FIG. 7 is an axonometric view of a side of the hinge sub-assembly close to the flexible display panel when the foldable display device provided by an embodiment of the present disclosure is in the explanate state.

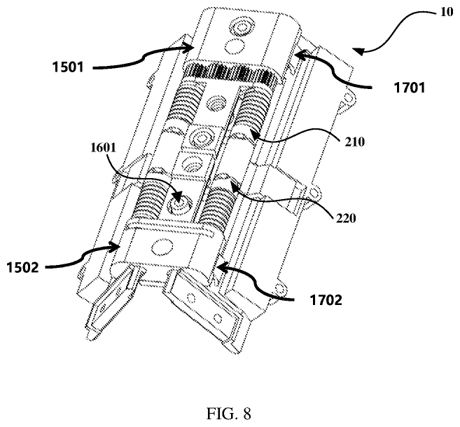

FIG. 8 is an axonometric view of the side of the hinge sub-assembly away from the flexible display panel when the foldable display device provided by an embodiment of the present disclosure is in the bending state.

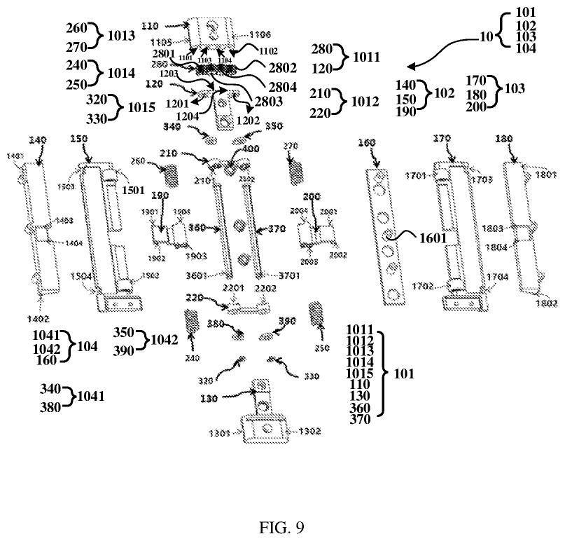

FIG. 9 is an exploded view of the hinge sub-assembly in the foldable display device provided by an embodiment of the present disclosure.

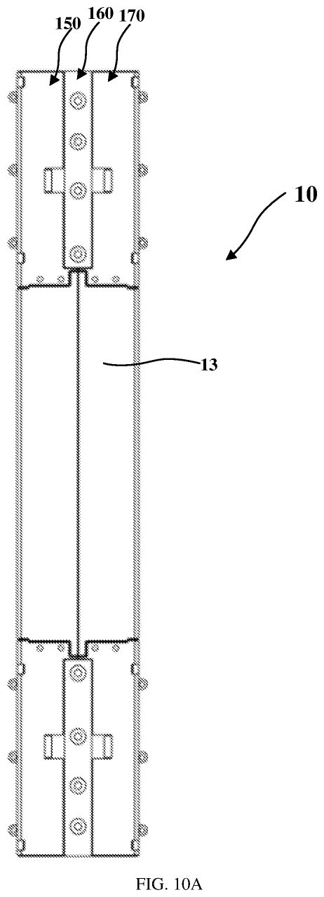

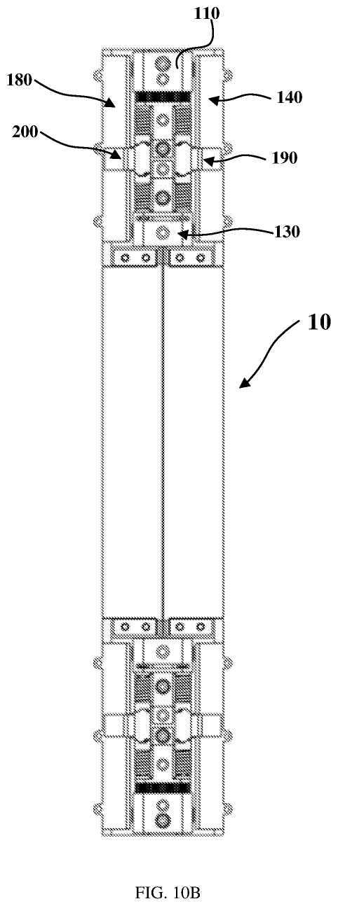

FIG. 10A is a front view of the side of the bending assembly close to the flexible display panel when the foldable display device provided by an embodiment of the present disclosure is in the explanate state.

FIG. 10B is a front view of the side of the bending assembly away from the flexible display panel when the foldable display device provided by an embodiment of the present disclosure is in the explanate state.

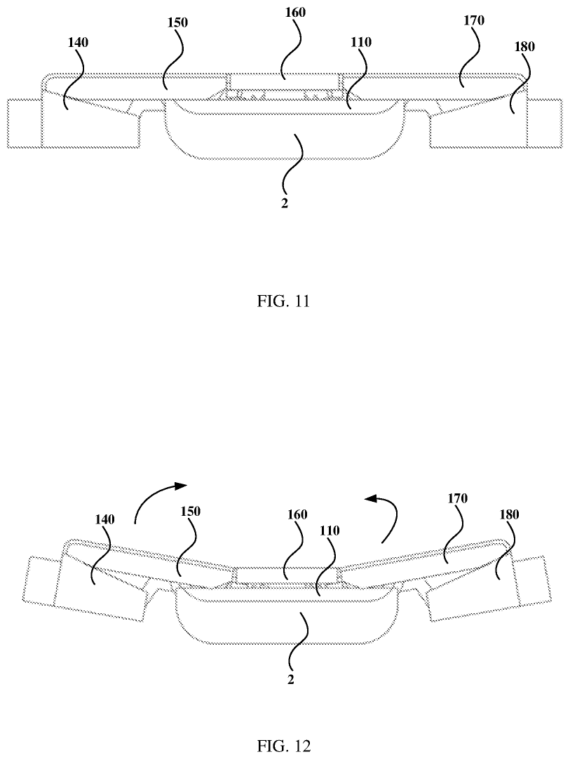

FIG. 11 is a schematic view of a lifting plate when the foldable display device provided by an embodiment of the present disclosure is in the explanate state.

FIG. 12 is a schematic view of the lifting plate when the foldable display device provided by an embodiment of the present disclosure is in the bending state.

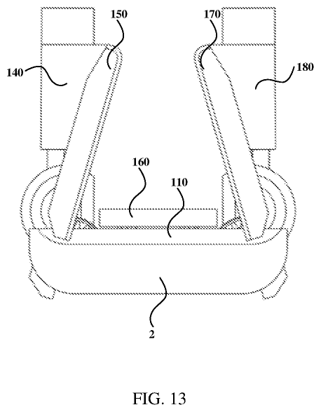

FIG. 13 is a schematic view of the lifting plate when the foldable display device provided by an embodiment of the present disclosure is in the fully folded state.

### EMBODIMENTS OF DISCLOSURE

### Detailed Description of Embodiments

The embodiments of the present disclosure are aimed at improving a technical problem that a foldable display device of a current technology is difficult to synchronously realize bending when the foldable display device of the current technology is in a bending state, which leads to a technical problem that it is difficult to realize seamless foldable in appearance. The embodiments of the present disclosure can solve the above-mentioned technical problems.

Please refer to FIG. 1 to FIG. 13, an embodiment of the present disclosure provides a foldable display device, and the foldable display device includes a shell body 100 and a flexible display panel 20; the shell body 100 includes a first shell 3, a second shell 4, and a bending assembly 1, and the flexible display panel 20 is disposed on one side of the first shell 3, the second shell 4, and the bending assembly 1. The bending assembly 1 is received in the shell body 100 and connected to the first shell 3 and the second shell 4; the bending assembly 1 includes at least two hinge sub-assemblies 10, and each of the hinge sub-assemblies 10 includes a synchronization mechanism 101, a first rotation mechanism 102, and a second rotation mechanism 103; the first rotation mechanism 102 is fixedly connected with the first shell 3 and arranged on one side of the synchronization mechanism 101, and the first rotation mechanism 102 is rotatably connected with the synchronization mechanism 101; the second rotation mechanism 103 is fixedly connected with the second shell 4 and arranged on one side of the synchronization mechanism 101 away from the first rotation mechanism 102, and the second rotation mechanism 103 is rotatably connected with the synchronization mechanism 101. The synchronization mechanism 101 includes a first guide component disposed close to the first shell 3 and a second guide component disposed close to the second shell 4, and the first rotation mechanism 102 includes a first transmission component 150; a first slide rail sub-component is disposed on one end of the first transmission component 150 close to the synchronization mechanism 101, and one end of the first transmission component 150 away from the synchronization mechanism 101 is rotatably connected with the first shell 3; the second rotation mechanism 103 includes a second transmission component 170, and a second slide rail sub-component is disposed on one side of the second transmission component 170 close to the synchronization mechanism 101, and one end of the second transmission component 170 away from the synchronization mechanism 101 is rotatably connected with the second shell 4.

Wherein when the flexible display panel 20 is in a flat state, the first slide rail sub-component cooperates with the first guide component, and the second slide rail sub-component cooperates with the second guide component; and when the flexible display panel 20 is in a bending state, the first slide rail sub-component is away from the first guide component, and the second slide rail sub-component is away from the second guide component.

In the foldable display device provided by the embodiments of the present disclosure, the bending assembly 1 is arranged in the shell body 100, wherein the bending assembly 1 includes at least two hinge sub-assemblies 10, and each of the hinge sub-assemblies 10 includes the synchronization mechanism 101, the first rotation mechanism 102, and the second rotation mechanism 103; the first rotation mechanism 102 is rotatably connected with the synchronization mechanism 101, and the second rotation mechanism 103 is rotatably connected with the synchronization mechanism 101, so that when the flexible display panel 20 changes between the explanate state and the bending state, the first transmission component 150 and the second transmission component 170 both act as an angle guide mechanism for the flexible display panel 20 and act as an arc-shaped rotation mechanism, which can enhance stability of the hinge sub-assemblies 10. At a same time, the second rotation mechanism 103 rotates synchronously with the first rotation mechanism 102 through the synchronization mechanism 101, so that the foldable display device always maintains a symmetrical state during a bending process; furthermore, when the foldable display device is completely folded, the flexible portion 201 (see below) of the flexible display panel 20 is in a water drop-like folded state, which further realizes the seamless foldable of the foldable display device in appearance.

The technical solutions of the present disclosure will now be described in combination with specific embodiments.

Please refer to FIG. 1, FIG. 1 is a schematic view of a relationship between a flexible display panel 20, a shell body 100, and a bending assembly 1 in a foldable display device provided by an embodiment of the present disclosure. Please refer to FIG. 2, FIG. 2 is a schematic view of a relationship between the shell body 100 and the bending assembly 1 in the foldable display device provided by an embodiment of the present disclosure. Wherein as can be seen from FIG. 1 and FIG. 2, the foldable display device includes the shell body 100 and the flexible display panel 20; the shell body 100 includes a first shell 3, a second shell 4, and the bending assembly 1. The flexible display panel 20 includes a flexible portion 201, and the flexible display panel 20 is disposed in the shell body 100 and is disposed on one side of the first shell 3, the second shell 4, and the bending assembly 1. The bending assembly 1 is received in the shell body 100 and connected to the first shell 3 and the second shell 4.

Wherein the flexible portion 201 is provided corresponding to the bending assembly 1.

In an embodiment of the present disclosure, the foldable display device further includes a rotating shaft cover 2, and the rotating shaft cover 2 is disposed on one side of the shell body 100 away from the flexible display panel 20; wherein in a direction of a top view of the foldable display device, an orthographic projection of the bending assembly 1 on the rotating shaft cover 2 coincides with the rotating shaft cover 2.

Further, as shown in FIG. 1, in an embodiment of the present disclosure, the bending assembly 1 includes a first hinge sub-assembly 11 and a second hinge sub-assembly 12, and the first hinge sub-assembly 11 is rotatably connected with the second hinge sub-assembly 12 through a supporting plate 13.

Wherein a hinge mechanism is designed to be the first hinge sub-assembly 11 and the second hinge sub-assembly 12 by the bending assembly 1, torsion output of the hinge mechanism can be realized in two ends of the supporting plate 13, respectively, which can prevent a difficulty in processing or a deformation problem caused by an excessive length of a motion board in the first hinge sub-assembly 11 and the second hinge sub-assembly 12.

As shown in FIG. 3A, FIG. 3A is an axonometric view of a side of the bending assembly 1 close to the flexible display panel 20 when the foldable display device provided by an embodiment of the present disclosure is in the explanate state; as shown in FIG. 3B, FIG. 3B is an axonometric view of a side of the bending assembly 1 away from the flexible display panel 20 when the foldable display device provided by an embodiment of the present disclosure is in the explanate state; as shown in FIG. 4, FIG. 4 is a schematic view of cooperation between the flexible display panel 20 and the bending assembly 1 in a fully folded state of the foldable display device provided by an embodiment of the present disclosure; as shown in FIG. 5A, FIG. 5A is an axonometric view of the side of the bending assembly 1 close to the flexible display panel 20 when the foldable display device provided by an embodiment of the present disclosure is in the bending state; and as shown in FIG. 5B, FIG. 5B is an axonometric view of the side of the bending assembly 1 away from the flexible display panel 20 when the foldable display device provided by an embodiment of the present disclosure is in the bending state.

Specifically, as can be seen from FIGS. 3A to 5B, when the foldable display device is in a flattened state, the first shell 3, the second shell 4, and the bending assembly 1 are in a same plane; when the foldable display device is in a bending state (bending inward), the first shell 3 and the second shell 4 are symmetrically arranged with respect to a longitudinal symmetrical axis of the bending assembly 1; and when the foldable display device is in a completely bended state, the flexible display panel 20 produces a water drop-like bending shape in a space formed by the bending assembly 1.

As shown in FIG. 6, FIG. 6 is an axonometric view of a side of a hinge sub-assembly 10 away from the flexible display panel 20 when the foldable display device provided by an embodiment of the present disclosure is in the explanate state. As shown in FIG. 7, FIG. 7 is an axonometric view of a side of the hinge sub-assembly 10 close to the flexible display panel 20 when the foldable display device provided by an embodiment of the present disclosure is in the explanate state. As shown in FIG. 8, FIG. 8 is an axonometric view of the side of the hinge sub-assembly 10 away from the flexible display panel 20 when the foldable display device provided by an embodiment of the present disclosure is in the bending state. As shown in FIG. 9, FIG. 9 is an exploded view of the hinge sub-assembly 10 provided by the foldable display device provided by an embodiment of the present disclosure. As shown in FIG. 10A, FIG. 10A is a front view of the side of the bending assembly 1 close to the flexible display panel 20 when the foldable display device provided by an embodiment of the present disclosure is in the explanate state. As shown in FIG. 10B, FIG. 10B is a front view of the side of the bending assembly 1 away from the flexible display panel 20 when the foldable display device provided by an embodiment of the present disclosure is in the explanate state.

As can be seen from FIG. 6 to FIG. 10B, each of the hinge sub-assemblies 10 of the foldable display device provided by an embodiment of the present disclosure includes a synchronization mechanism 101, a first rotation mechanism 102, and a second rotation mechanism 103; the first rotation mechanism 102 is arranged on one side of the synchronization mechanism 101, and the second rotation mechanism 103 is arranged on a side of the synchronization mechanism 101 away from the first rotation mechanism 102.

Wherein the first rotation mechanism 102 is fixedly connected with the first shell 3 and is rotatably connected with the synchronization mechanism 101; the second rotation mechanism 103 is fixedly connected with the second shell 4 and is rotatably connected with the synchronization mechanism 101.

Specifically, when the flexible display panel 20 changes between the explanate state and the bending state, the second rotation mechanism 103 rotates synchronously with the first rotation mechanism 102 through the synchronization mechanism 101; that is, the synchronization mechanism 101 is configured to always maintain the foldable display device in a symmetrical state during a bending process, so that when the foldable display device is completely folded, the flexible portion 201 of the flexible display panel 20 is in a water drop-like folded state, which further realizes the seamless foldable of the foldable display device in appearance.

In an embodiment of the present disclosure, the synchronization mechanism 101 includes a first principal axis 360 and a second principal axis 370, and the first principal axis 360 and the second principal axis 370 are both main body connectors of the synchronization mechanism 101. Wherein the first rotation mechanism 102 is sleeved on the first principal axis 360 and is rotatably connected with the first principal axis 360, and the second rotation mechanism 103 is sleeved on the second principal axis 370 and is rotatably connected with the second principal axis 370.

Further, the first principal axis 360 is rotatably connected with the second principal axis 370 by a gear component 1011.

Further, a longitudinal direction of a supporting plate 13 is parallel with a longitudinal direction of the first principal axis 360 or the second principal axis 370.

In an embodiment of the present disclosure, the gear component 1011 includes a sub-gear component 280, the sub-gear component 280 includes a first gear 2801, a second gear 2802, a third gear 2803, and a fourth gear 2804.

Wherein the first gear 2801 is sleeved on the first principal axis 360 through a first inner hole, and the second gear 2802 is sleeved on the second principal axis 370 through a second inner hole; in this way, the first gear 2801 can rotate with the first principal axis 360 through a flat position, and at a same time, the second gear 2802 can rotate with the second principal axis 370 through the flat position. Wherein, both the first gear 2801 and the first principal axis 360 are provided with the flat position; the flat position of the first gear 2801 is arranged on a first inner hole wall of the first inner hole, and the flat position of the first principal axis 360 is in cooperation with the flat position of the first gear 2801; at a same time, the second gear 2802 and the second principal axis 370 are both provided with the flat positions, and the flat position of the second gear 2802 is arranged on a second inner hole wall of the second inner hole, and the flat position of the second principal axis 370 is in cooperation with the flat position of the second gear 2802.

A purpose of the above-mentioned design of the flat position is that it is difficult to fix a circle or other shape, and the flat position formed by milling is used for fixing or clamping. Further, the third gear 2803 is meshed with the first gear 2801, and the fourth gear 2804 is meshed with the third gear 2803 and the second gear 2802, respectively. In this way, when an external driving force drives the first gear 2801 to rotate, the first gear 2801 drives the third gear 2803 to rotate, the third gear 2803 drives the fourth gear 2804 to rotate, and the fourth gear 2804 drives the second gear 2802 to rotate; when the external driving force is transmitted to the second gear 2802, the second gear 2802 drives the fourth gear 2804 to rotate, the fourth gear 2804 drives the third gear 2803 to rotate, and the third gear 2803 drives the first gear 2801 to rotate.

In an embodiment of the present disclosure, the gear component 1011 further includes a gear fixing bracket 120, the gear fixing bracket 120 is provided with a first gear via 1201, a second gear via 1202, a third gear via 1203, and a fourth gear via 1204.

Wherein the gear fixing bracket 120 is sleeved on the first principal axis 360 by the first gear via 1201, and the gear fixing bracket 120 is sleeved on the second principal axis 370 by the second gear via 1202; the third gear 2803 includes a first gear protrusion arranged along a direction parallel to the first principal axis 360. The first gear protrusion includes a first sub-gear protrusion disposed near a first slide rail bracket 110 and a second sub-gear protrusion disposed near the gear fixing bracket 120.

The fourth gear 2804 includes a second gear protrusion disposed along the direction parallel to the first principal axis 360, and the second gear protrusion includes a third sub-gear protrusion disposed close to the first slide rail bracket 110 and a fourth sub-gear protrusion disposed close to the gear fixing bracket 120.

In the foldable display device provided in the embodiment of the present disclosure, the gear fixing bracket 120 is disposed mainly for positioning the gear sub-component 280, so as to prevent the foldable display device from being misplaced during the foldable process and causing damage to the flexible display panel 20.

In an embodiment of the present disclosure, the synchronization mechanism 101 further includes a first slide rail bracket 110, the first slide rail bracket 110 is provided with a fifth gear via 1101, a sixth gear via 1102, a seventh gear via 1103, and an eighth gear via 1104.

Wherein the first slide rail bracket 110 is sleeved on the first principal axis 360 by the fifth gear via 1101, and the first slide rail bracket 110 is sleeved on the second principal axis 370 by the sixth gear via 1102.

Further, the third gear 2803 is a solid gear, the first gear protrusion is integrally formed with a main body of the third gear 2803, and the first gear protrusion is used to fix the third gear 2803 between the first slide rail bracket 110 and the gear fixing bracket 120; the fourth gear 2804 is a solid gear, the second gear protrusion is integrally formed with a main body of the fourth gear 2804, the second gear protrusion is used to fix the fourth gear 2804 between the first slide rail bracket 110 and the gear fixing bracket 120.

Further, the second sub-gear protrusion is disposed opposite to the first sub-gear protrusion, the first sub-gear protrusion cooperates with the seventh gear via 1103, and the second sub-gear protrusion cooperates with the third gear via 1203. The third sub-gear protrusion is disposed opposite to the fourth sub-gear protrusion, and the third sub-gear protrusion cooperates with the eighth gear via 1104, and the fourth sub-gear protrusion cooperates with the fourth gear via 1204.

Preferably, both the first gear protrusion or the second gear protrusion are arc-shaped protrusions. Specifically, the first slide rail bracket 110 and the gear fixing bracket 120 do not rotate with the first principal axis 360 or the second principal axis 370, and functions thereof are mainly for positioning the first principal axis 360 and the second principal axis 370.

In an embodiment of the present disclosure, the first rotation mechanism 102 includes a first transmission component 150; a side of the first transmission component 150 close to the first slide rail bracket 110 is provided with a first slide rail sub-component, and the first slide rail sub-component includes a first slide rail 1501; the second rotation mechanism 103 includes a second transmission component 170, a side of the second transmission component 170 close to the first slide rail bracket 110 is provided with a second slide rail sub-component, and the second slide rail sub-component includes a second slide rail 1701; wherein when the foldable display device is in a folded state, the first transmission component 150 and the second transmission component 170 are turned over at a definite angle, so that the flexible display panel 20 forms a water drop shape.

Further, the first slide rail bracket 110 includes a first slide rail guide portion 1105 close to the first transmission component 150 and a second slide rail guide portion 1106 close to the second transmission component 170. The first slide rail guide portion 1105 is mainly used to provide a movement track for the first slide rail 1501, and the second slide rail guide portion 1106 is mainly used to provide a movement track for the second slide rail 1701. Preferably, the first slide rail guide portion 1105 and the second slide rail guide portion 1106 are arc-shaped. Further, when the flexible display portion 201 is in the explanate state, as shown in FIG. 3A, FIG. 3B, FIG. 10A, and FIG. 10B, the first slide rail 1501 cooperates with the first slide rail guide portion 1105, and the second slide rail 1701 cooperates with the second slide rail guide portion 1106; when the flexible display portion 201 is in the bending state, as shown in FIG. 4, FIG. 5A, FIG. 5B, and FIG. 8, the first slide rail 1501 is away from the first slide rail guide portion 1105, and the second slide rail 1701 is away from the second slide rail guide portion 1106.

In an embodiment of the present disclosure, the first rotation mechanism 102 further includes a first fixed component 140, a first end of the first fixed component 140 is fixedly connected to the first shell 3, and the first end of the first fixed component 140 is also rotatably connected to a side of the first transmission component 150 away from the first principal axis 360.

The second rotation mechanism 103 further comprises a second fixed component 180, a first end of the second fixed component 180 is fixedly connected to the second shell 4, and the first end of the second fixed component 180 is also rotatably connected to a side of the second transmission component 170 away from the first principal axis 360.

Further, the first fixed component 140 and a side of the first transmission component 150 away from the first principal axis 360 are movably connected through a first hinge-typed rotating shaft; a first end of the second fixed component 180 and a side of the second transmission component 170 away from the first principal axis 360 are movably connected through a second hinge-typed rotating shaft. Specifically, the first end of the first fixed component 140 is provided with a first connecting shaft hole 1401 and a second connecting shaft hole 1402, and a side of the first transmission component 150 away from the first principal axis 360 is provided with the first hinge-typed rotating shaft. The first hinge-typed rotating shaft includes a first sub-hinged rotating shaft 1503 disposed near the first slide rail bracket 110 and a second sub-hinged rotating shaft 1504 close to the second slide rail bracket 130; the first sub-hinged shaft 1503 cooperates with the first connecting shaft hole 1401, and the second sub-hinged rotating shaft 1504 cooperates with the second connecting shaft hole 1402, so that the first fixed component 140 is rotatably connected with the first transmission component 150.

Specifically, a first end of the second fixed component 180 is provided with a third connecting shaft hole 1801 and a fourth connecting shaft hole 1802; a side of the second transmission component 170 away from the first principal axis 360 is provided with the second hinge-typed rotating shaft, and the second hinge-typed rotating shaft includes a third sub-hinged rotating shaft 1703 disposed close to the first slide rail bracket 110 and a fourth sub-hinged rotating shaft 1704 close to the second slide rail bracket 130; the third sub-hinge shaft 1703 cooperates with the third connecting shaft hole 1801, and the fourth sub-hinged rotating shaft 1704 cooperates with the fourth connecting shaft hole 1802, so that the second fixed component 180 is rotatably connected with the second transmission component 170.

In an embodiment of the present disclosure, the first rotation mechanism 102 further includes a first torsion arm 190, and a first end of the first torsion arm 190 is rotatably connected to a second end of the first fixed component 140; the second rotation mechanism 103 further includes a second torsion arm 200, a first end of the second torsion arm 200 is rotatably connected to a second end of the second fixed component 180.

Wherein the first transmission component 150 is sandwiched between the first torsion arm 190 and the first fixed component 140, and the second transmission component 170 is sandwiched between the second torsion arm 200 and the second fixed component 180.

Further, the second end of the first fixed component 140 is provided with a first displacement compensation sliding groove 1403 and a second displacement compensation sliding groove 1404, and the first end of the first torsion arm 190 is provided with a first sub-slide rail 1901 and a second sub-slide rail 1902, the first sub-slide rail 1901 and the second sub-slide rail 1902 are arranged symmetrically with respect to a first symmetry axis of the first torsion arm 190 in a short side direction of the first fixed component 140; the first sub-slide rail 1901 is inserted in the first displacement compensation sliding groove 1403, and the second sub-slide rail 1902 is inserted in the second displacement compensation sliding groove 1404.

The second end of the second fixed component 180 is provided with a third displacement compensation sliding groove 1803 and a fourth displacement compensation sliding groove 1804, and the first end of the second torsion arm 200 is provided with a third sub-slide rail 2001 and a fourth sub-slide rail 2002, the third sub-slide rail 2001 and the fourth sub-slide rail 2002 are arranged symmetrically with respect to a second symmetry axis of the second torsion arm 200 in a short side direction of the second fixed component 180; the third sub-slide rail 2001 is inserted in the third displacement compensation sliding groove 1803, and the fourth sub-slide rail 2002 is inserted in the fourth displacement compensation sliding groove 1804.

Wherein the first displacement compensation sliding groove 1403 and the second displacement compensation sliding groove 1404 are arranged symmetrically with respect to a symmetry axis of the first transmission component 150 in a short side direction; the third displacement compensation sliding groove 1803 and the fourth displacement compensation sliding groove 1804 are symmetrically arranged with respect to the symmetry axis of the first transmission component 150 in the short side direction.

Further, the first sub-slide rail 1901, the second sub-slide rail 1902, the third sub-slide rail 2001, and the fourth sub-slide rail 2002 are all linear slide rails; the first displacement compensation sliding groove 1403 and the second displacement compensation sliding groove 1404 are used to compensate a displacement generated during a rotation of the first torsion arm 190, and the third displacement compensation sliding groove 1803 and the fourth displacement compensation sliding groove 1804 are used to compensate a displacement generated during a rotation of the second torsion arm 200.

In an embodiment of the present disclosure, a second end of the first torsion arm 190 is sleeved on the first principal axis 360, and a second end of the second torsion arm 200 is sleeved on the second principal axis 70.

The second end of the first torsion arm 190 is provided with a first sub-cam 1904 and a second sub-cam 1903, the first sub-cam 1904 and the second sub-cam 1903 are symmetrically arranged with respect to a first symmetry axis of the first torsion arm 190 in a short side direction of the first fixed component 140, and the first sub-cam 1904 and the second sub-cam 1903 are both sleeved on the first principal axis 360. The second end of the second torsion arm 200 is provided with a third sub-cam 2004 and a fourth sub-cam 2003, the third sub-cam 2004 and the fourth sub-cam 2003 are symmetrically arranged with respect to a second symmetry axis of the second torsion arm 200 in a short side direction of the second fixed component 180, and the third sub-cam 2004 and the fourth sub-cam 2003 are both sleeved on the second principal axis 370.

In an embodiment of the present disclosure, the synchronization mechanism 101 further includes a cam component 1012, and the cam component 1012 includes a first cam sub-component 210 and a second cam sub-component 220; a first end of the first cam sub-component 210 is provided with a fifth sub-cam 2101, and the fifth sub-cam 2101 is sleeved on the first principal axis 360; and a second end of the first cam sub-component 210 is provided with a sixth sub-cam 2102, and the sixth sub-cam 2102 is sleeved on the second principal axis 370.

A first end of the second cam sub-component 220 is provided with a seventh sub-cam 2201, and the seventh sub-cam 2201 is sleeved on the first principal axis 360; and a second end of the second cam sub-component 220 is provided with an eighth sub-cam 2202, and the eighth sub-cam 2202 is sleeved on the second principal axis 370.

Wherein a side of the second end of the first torsion arm 190 close to the first cam sub-component 210 is engaged with the first end of the first cam sub-component 210, and a side of the second end of the first torsion arm 190 away from the first cam sub-component 210 is engaged with the first end of the second cam sub-component 220; that is, the first sub-cam 1904 and the fifth sub-cam 2101 are engaged with each other, and the second sub-cam 1903 and the seventh sub-cam 2201 are engaged with each other.

A side of the second end of the second torsion arm 200 close to the first cam sub-component 210 is engaged with the second end of the first cam sub-component 210, and a side of the second end of the second torsion arm 200 away from the first cam sub-component 210 is engaged with the second end of the second cam sub-component 220; that is, the third sub-cam 2004 and the sixth sub-cam 2102 are engaged with each other, and the fourth sub-cam 2003 and the eighth sub-cam 2202 are engaged with each other.

In an embodiment of the present disclosure, the synchronization mechanism 101 further includes a first spring component 1013, and the first spring component 1013 is disposed between the first cam sub-component 210 and the gear fixing bracket 120.

Wherein the first spring component 1013 includes first spring 260 and second spring 270, the first spring 260 is sleeved on the first principal axis 360, and the second spring 270 is sleeved on the second principal axis 370.

In an embodiment of the present disclosure, the synchronization mechanism 101 further includes a second slide rail bracket 130 and a second spring component 1014; one end of the second slide rail bracket 130 is sleeved on the first principal axis 360, and another end of the second slide rail bracket 130 is sleeved on the second principal axis 370.

Wherein the second spring component 1014 is disposed between the second cam sub-component 220 and the second slide rail bracket 130, and the second spring component 1014 includes a third spring 240 and a fourth spring 250; the third spring 240 is sleeved on the first principal axis 360, and the fourth spring 250 is sleeved on the second principal axis 370.

In an embodiment of the present disclosure, one end of the first spring 260 is limited by the gear fixing bracket 120, and another end of the first spring 260 is limited by the fifth sub-cam 2101; one end of the second spring 270 is limited by the gear fixing bracket 120, and another end of the second spring 270 is limited by the sixth sub-cam 2102; one end of the third spring 240 is limited by the seventh sub-cam 2201, and another end of the third spring 240 is limited by the second slide rail bracket 130; one end of the fourth spring 250 is limited by the eighth sub-cam 2202, and another end of the fourth spring 250 is limited by the second slide rail bracket 130.

Therefore, when the first torsion arm 190 or the second torsion arm 200 rotates, the cam component 1012 is driven to move on the first principal axis 360 and the second principal axis 370 along a length direction of the first principal axis 360, so that the cam component 1012 compresses the first spring component 1013 or the second spring component 1014, thereby causing the first spring component 1013 or the second spring component 1014 to generate a torsional force.

In an embodiment of the present disclosure, the second slide rail bracket 130 includes a third slide rail guide portion 1301 close to the first transmission component 150 and a fourth slide rail guide portion 1302 close to the second transmission component 170; one side of the first transmission component 150 close to the second slide rail bracket 130 is disposed with a third slide rail 1502, one side of the second transmission component 170 close to the second slide rail bracket 130 is disposed with a fourth slide rail 1702.

Wherein the first slide rail 1501 and the third slide rail 1502 form a first slide rail sub-component of the first transmission component 150, and the second slide rail 1701 and the fourth slide rail 1702 form a second slide rail sub-component of the second transmission component 170.

The first slide rail guide portion 1105 and the third slide rail guide portion 1301 form a first guide component of the synchronization mechanism 101, and the second slide rail guide portion 1106 and the fourth slide rail guide portion 1302 form a second guide component of the synchronization mechanism 101.

Wherein the third slide rail guide portion 1301 is mainly used to provide a movement track of the third slide rail 1502, and the fourth slide rail guide portion 1302 is mainly used to provide a movement track of the fourth slide rail 1702. Preferably, shapes of the third slide rail guide portion 1301 and the fourth slide rail guide portion 1302 are arc-shaped.

Further, when the flexible portion 201 is in the explanate state, as shown in FIG. 3A, FIG. 3B, FIG. 10A, and FIG. 10B, the third slide rail 1502 cooperates with the third slide rail guide portion 1301, and the fourth slide rail 1702 cooperates with the fourth slide rail guide portion 1302; when the flexible portion 201 is in the bending state, as shown in FIG. 4, FIG. 5A, FIG. 5B, and FIG. 8, the third slide rail 1502 is away from the third slide rail guide portion 1301, the fourth slide rail 1702 is away from the fourth slide rail guide portion 1302.

In an embodiment of the present disclosure, the synchronization mechanism 101 further includes a lock catch component 1015; the lock catch component 1015 is sleeved on the first principal axis 360 and the second principal axis 370, and the lock catch component 1015 is disposed on one side of the second slide rail bracket 130 away from the second spring component 1014.

Wherein the lock catch component 1015 includes a first lock catch 320 and a second lock catch 330; the first lock catch 320 is threadedly connected to the first principal axis 360, and the second lock catch 330 is threadedly connected to the second principal axis 370.

Further, the lock catch component 1015 is used to fasten and limit the second slide rail bracket 130.

In an embodiment of the present disclosure, one end of the first principal axis 360 or the second principal axis 370 close to the first slide rail bracket 110 is designed with a T-head, and therefore, there is no need to design the lock catch component 1015 at the one end of the first principal axis 360 or the second principal axis 370 close to the first slide rail bracket 110.

Further, one end of the first principal axis 360 close to the first lock catch 320 is provided with a first sub-groove 3601, and the first sub-groove 3601 is threadedly engaged with the first lock catch 320; one end of the second principal axis 370 close to the second lock catch 330 is provided with a second sub-groove 3701, and the second sub-groove 3701 is threadedly engaged with the second lock catch 330.

In an embodiment of the present disclosure, the hinge sub-assembly 10 further includes a lifting mechanism 104, and the lifting mechanism 104 includes a lifting plate 160, and the lifting plate 160 is disposed between the first principal axis 360 and the second principal axis 370 and arranged along a length direction of the first principal axis 360.

Wherein a first end of the lifting plate 160 is movably connected to the first slide rail bracket 110 and the gear fixing bracket 120, and a second end of the lifting plate 160 is movably connected to the second slide rail bracket 130.

Specifically, as shown in FIG. 6 and FIG. 8, a side of the lifting plate 160 close to the flexible display panel 20 is provided with a first bolt 161, a second bolt 162, a third bolt 163, and a fourth bolt 164. The first bolt 161 partially penetrates the first slide rail bracket 110, the second bolt 162 partially penetrates the gear fixing bracket 120, and the third bolt 163 and the fourth bolt 164 partially penetrate the second slide rail bracket 130. Wherein, functions of the first bolt 161, the second bolt 162, the third bolt 163, and the fourth bolt 164 are mainly used to keep the lifting plate 160 stationary in a direction parallel to the shell body 100.

Further, the lifting mechanism 104 further includes a first paddle component group 1041 sleeved on the first principal axis 360 and a second paddle component group 1042 sleeved on the second principal axis 370; the first paddle component group 1041 is flatly sleeved on the first principal axis 360 through an inner hole and rotates with a rotation of the first principal axis 360, and the second paddle component group 1042 is flatly sleeved on the second principal axis 370 through the inner hole and rotates with a rotation of the second principal axis 370.

Wherein the first paddle component group 1041 includes a first paddle component 340 and a second paddle component 380; the first paddle component 340 is disposed between the gear fixing bracket 120 and the first spring 260, and the second paddle component 380 is disposed between the second slide rail bracket 130 and the third spring 240.

The second paddle component group 1042 includes a third paddle component 350 and a fourth paddle component 390; the third paddle component 350 is disposed between the gear fixing bracket 120 and the second spring 270, and the fourth paddle component 390 is disposed between the second slide rail bracket 130 and the fourth spring 250.

Wherein the first paddle component 340, the second paddle component 380, the third paddle component 350, and the fourth paddle component 390 are all provided with a boss sub-component, and each of the boss sub-component is used to move the lifting plate 160 along a direction perpendicular to a top view of the foldable display device.

Further, the lifting mechanism 104 further includes a third spring component, and the third spring component includes a plurality of spring sub-components 400; the lifting plate 160 is provided with a plurality of raised components 1601 along the direction perpendicular to the top view of the foldable display device; each of the raised components 1601 penetrates any one of the first slide rail bracket 110, the gear fixing bracket 120, and the second slide rail bracket 130. Preferably, the lifting plate 160 includes three raised components 1601, and a shape of the raised components 1601 is cylinder-shaped.

Wherein in the direction perpendicular to the top view of the foldable display device, each of the spring sub-components 400 is sleeved on a corresponding one of the raised components 1601.

As shown in FIG. 11, it is a schematic view of the lifting plate 160 when the foldable display device provided by an embodiment of the present disclosure is in the explanate state; wherein when the flexible portion 201 is in the explanate state, boss sub-components on the first paddle component group 1041 and the second paddle component group 1042 boss sub-components on the first paddle component 340 and the third paddle component 350 are in contact with the lifting plate 160, and a plurality of the boss sub-components bear against the lifting plate 160, thereby driving the lifting plate 160 to rise. The lifting plate 160 is lifted to a definite distance under driving of the boss sub-components. When the flexible portion 201 is fully expanded, the lifting plate 160 contacts the flexible portion 201 and supports the flexible portion 201.

As shown in FIG. 12, it is a schematic diagram of the lifting plate 160 when the foldable display device provided by an embodiment of the present disclosure is in the bending state; wherein when the foldable display device is in a transition state from the explanate state to the bending state, the lifting plate 160 moves in a direction away from the flexible display panel 20.

As shown in FIG. 13, it is a schematic view of the lifting plate 160 when the foldable display device provided by an embodiment of the present disclosure is in the fully folded state; wherein when the flexible portion 201 is in a fully bended state, the plurality of boss sub-components of the first paddle component group 1041 and the second paddle component group 1042 are pulled away from the lifting plate 160. The lifting plate 160 is pulled down under a push of an elastic force generated by the third spring component, and the flexible display panel 20 is space-avoided in the direction of the top view of the foldable display device; the lifting plate 160 is far away from the flexible portion 201 and is infinitely close to the shaft cover 2, and there is a gap between the lifting plate 160 and the flexible portion 201, as shown in FIG. 4.

The lifting plate 160 provided by the embodiment of the present disclosure automatically rises or sinks along with a foldable movement of the flexible portion 201 of the flexible display panel 20, which can effectively protect the flexible display panel 20 and prevent the flexible display panel 20 from being squeezed, which is realized mainly by the first paddle component group 1041, the second paddle component group 1042, and the third spring component.

Further, the first principal axis 360 acts as a main body connecting component of the synchronizing mechanism 101, and in a direction from the first slide rail bracket 110 to the second slide rail bracket 130, the first principal axis 360 is connected to the first slide rail bracket 110, the first gear 2801, the gear fixing bracket 120, the first paddle component 340, the first spring 260, the first cam sub-component 210, the first torsion arm 190, the second cam sub-component 220, the third spring 240, the third paddle component 350, the second slide rail bracket 130, and the first lock catch 320 in sequence.

The second principal axis 370 acts as a main body connecting component of the synchronizing mechanism 101, and in the direction from the first slide rail bracket 110 to the second slide rail bracket 130, the second principal axis 370 is connected to the slide rail bracket 110, the second gear 2802, the gear fixing bracket 120, the second paddle component 380, the second spring 270, the first cam sub-component 210, the second torsion arm 200, the second cam sub-component 220, the fourth spring 250, the fourth paddle component 390, the second slide rail bracket 130, and the second lock catch 330 in sequence.

Specifically, in the above-mentioned embodiments of the present disclosure, a rotation principle and process of the foldable display device is as follows:

As shown in FIG. 3A to FIG. 10B, when the flexible portion 201 changes from the explanate state to the bending state, the shell body 100 of the foldable display device is driven by an external force to fold inward along with the first shell 3, and the first shell 3 drives the first fixed component 140 on one side of the first shell 3 to rotate under driving of the external force; after that, the first fixed component 140 drives the first transmission component 150 to rotate through the first hinge-typed rotating shaft, and the first transmission component 150 drives the first slide rail 1501 to rotate and slide out of the first slide rail guide portion 1105 after rotating, and at a same time, the first transmission component 150 drives the third slide rail 1502 to rotate and slide out of the third slide rail guide portion 1301; at the same time, the first transmission component 150 drives the first torsion arm 190 to rotate inwardly of the flexible display panel 20 through the first displacement compensation sliding groove 1403 and the second displacement compensation sliding groove 1404 on the first fixed component 140; after that, the first sub-cam 1904 or the second sub-cam 1903 of the first torsion arm 190 drives the cam component 1012 to move on the first principal axis 360 and the second principal axis 370 along the length direction of the first principal axis 360, so that the cam component 1012 compresses the first spring component 1013 and the second spring component 1014, so that the first spring component 1013 and the second spring component 1014 generate a torsional force; after that, the torsional force drives the first principal axis 360 to rotate, and the first principal axis 360 drives the first paddle component 340 and the third paddle component 350 to rotate; after the first paddle component 340 and the third paddle component 350 are rotated, the boss sub-components on the first paddle component 340 and the third paddle component 350 are pulled away from the lifting plate 160, and the lifting plate 160 is pulled down under the push of the elastic force generated by the third spring component. The flexible display panel 20 is space-avoided in the direction of the top view of the foldable display device.

In the above process, the first principal axis 360 drives the first gear 2801 to rotate at the same time, the first gear 2801 engages with the third gear 2803, and then drives the second principal axis 370 on another side to rotate, so that the second shell 4 on another side moves synchronously.

In another case of the embodiment of the present disclosure, when the flexible portion 201 changes from the bending state to the explanate state, the shell body 100 of the foldable display device is driven by an external force to turn outwards along with the first shell 3, and the first shell 3 drives the first fixed component 140 on one side of the first shell 3 to rotate outwards under driving of the external force; after that, the first fixed component 140 drives the first transmission component 150 to rotate through the first hinge-typed rotating shaft, and the first transmission component 150 drives the first slide rail 1501 to rotate and slide into an arc-shaped track formed by the first slide rail guide portion 1105; at a same time, the first transmission component 150 drives the third slide rail 1502 to rotate and slide into an arc-shaped track formed by the third slide rail guide portion 1301; at a same time, the first transmission component 150 drives the first torsion arm 190 to rotate outwardly of the flexible display panel 20 through the first displacement compensation sliding groove 1403 and the second displacement compensation sliding groove 1404 on the first fixed component 140; after that, the first sub-cam 1904 or the second sub-cam 1903 of the first torsion arm 190 drives the cam component 1012 to move on the first principal axis 360 and the second principal axis 370 along the length direction of the first principal axis 360, so that the cam component 1012 compresses the first spring component 1013 and the second spring component 1014, so that the first spring component 1013 and the second spring component 1014 generate a torsional force; after that, the torsional force drives the first principal axis 360 to rotate, and the first principal axis 360 drives the first paddle component 340 and the third paddle component 350 to rotate, after the first paddle component 340 and the third paddle component 350 are rotated, the boss sub-components on the first paddle component 340 and the third paddle component 350 are in contact with the lifting plate 160, and a plurality of the boss sub-components bear against the lifting plate 160, thereby driving the lifting plate 160 to rise; and the lift plate 160 is lifted to a definite distance under the driving of the boss sub-components. When the flexible portion 201 is fully expanded, the lifting plate 160 contacts the flexible portion 201 and supports the flexible portion 201.

In the above process, the first principal axis 360 drives the first gear 2801 to rotate at the same time, and the first gear 2801 engages with the third gear 2803, thereby driving the second principal axis 370 on the another side to rotate, so that the second shell 4 on the another side moves synchronously.

Compared with the prior art, the foldable display device provided in the embodiments of the present disclosure has the following features:

Firstly, the first slide rail 1501 and the third slide rail 1502 in the first transmission component 150 are distributed vertically symmetrical on one side, and the second slide rail 1701 and the fourth slide rail 1702 in the second transmission component 170 are distributed vertically symmetrical on one side, which spans an entire frame of the hinge sub-assemblies 10 and can fully surround the hinge sub-assemblies 10; at a same time, the first slide rail bracket 110 includes a first slide rail guide portion 1105 and a third slide rail guide portion 1301, and the second slide rail bracket 130 includes a third slide rail guide portion 1301 and a fourth slide rail guide portion 1302, which make integrity of the hinge sub-assemblies 10 better and make a structure thereof more stable; the first slide rail 1501, the second slide rail 1701, the third slide rail 1502, and the fourth slide rail 1702 in FIG. 8 can serve as a water drop-shaped moving plate, and the water drop-shaped moving plate mainly guides the flexible display panel 20 to fold in a water drop shape during a movement process; the first transmission component 150 and the second transmission component 170 are not only angle guide mechanisms of the flexible display panel 20, but also arc-shaped rotation mechanisms.

Secondly, the first fixed component 140 and the first transmission component 150 are movably connected by means of the first hinge-typed rotating shaft; the second fixed component 180 and the second transmission component 170 are movably connected through the second hinge-typed rotating shaft, and the first hinge-typed rotating shaft and the second hinge-typed rotating shaft are uniaxial hinges; a purpose of this design is to allow the first fixed component 140 to be movably connected with the first transmission component 150, and at a same time, to allow the second fixed component 180 to be movably connected with the second transmission component 170; since the first fixed component 140 is fixedly connected with the first shell 3 and the second fixed component 180 is fixedly connected with the second shell 4, so that the first transmission component 150 drives the first shell 3 to move during the movement process, and at a same time, the second transmission component 170 drives the second shell 4 to move during the movement process, so that the first shell 3 and the second shell 4 guide the flexible display panel 20 to fold in a form of water droplets. Thirdly, the first torsion arm 190 and the first fixed component 140 generate a connection and a motion compensation by a linear sliding groove structure, and the second torsion arm 200 and the second fixed component 180 generate a connection and a motion compensation by the linear sliding groove structure; at a same time, the first torsion arm 190 is decoupled from the first transmission component 150 and only moves to avoid each other, and there is no movement interlocking relationship; the second torsion arm 200 is decoupled from the second transmission component 170 and moves to avoid each other, and there is no movement interlocking relationship; in addition, a sub-cam structure of the first torsion arm 190 and the second torsion arm 200 is a double-headed symmetrical layout and a narrow space method, so that the torsional force is stressed more uniform.

Fourthly, the gear sub-component 280 is arranged in the first slide rail bracket 110 and the gear fixing bracket 120, and four teeth are arranged independently. Gears on both sides are respectively sleeved on the principal axis and driven by the principal axis. Two gears in a middle are installed in the gear fixing bracket 120 and the first slide rail bracket 110 through a gear shaft.

Fifthly, a space formed after the bending assembly 1 is bent is larger due to mechanisms of the cam component 1012, the first spring component 1013, and the second spring component 1014, etc.; the lifting mechanism 104 is used to fill up spaces to prevent bumping, and the lifting mechanism 104 avoids the flexible portion 201 when the flexible portion 201 is folded, and the lifting mechanism 104 supports the flexible portion 201 when the flexible portion 201 is expanded.

Sixthly, the bending assembly 1 is arranged as two upper and lower hinge sub-assemblies 10, respectively, to realize a torque output of the hinge, and the two upper and lower hinge sub-assemblies 10 are connected by the supporting plate 13 in a middle, so as to prevent processing difficulties or deformation problems causing by an excessively long movement plate (i.e., the first slide rail bracket 110 and the second slide rail bracket 130).

In the above embodiments of the present disclosure, the bending assembly 1 may include a plurality of the hinge sub-assemblies, and a number of the hinge sub-assemblies 10 is determined by product sizes of the foldable display device.

In the above-mentioned embodiments, the description of each embodiment has its own emphasis. For parts that are not described in detail in a certain embodiment, reference may be made to the relevant descriptions of other embodiments.

The foldable display device provided by the embodiments of the present disclosure have been described above in detail, and specific examples are used in this paper to illustrate principles and implementations of the present invention. The description of the above embodiments is only used to help understand the technical solutions and core ideas of the disclosure, at a same time, for those skilled in the art, according to the idea of the present disclosure, there will be changes in the specific embodiments and disclosure scope. In summary, the content of this specification should not be construed as a limitation to the present disclosure.

What is claimed is:

1. A foldable display device, wherein the foldable display device comprises:
a shell body, the shell body including a first shell and a second shell; wherein the shell body further comprises a bending assembly, and the bending assembly is received in the shell body and connected to the first shell and the second shell; and
a flexible display panel, the flexible display panel disposed on one side of the first shell, the second shell, and the bending assembly;
wherein the bending assembly comprises at least two hinge sub-assemblies, and each of the hinge sub-assemblies comprises:
a synchronization mechanism comprising a first guide component disposed close to the first shell and a second guide component disposed close to the second shell;
a first rotation mechanism fixedly connected with the first shell and arranged on one side of the synchronization mechanism; wherein the first rotation mechanism is rotatably connected with the synchronization mechanism, and the first rotation mechanism comprises a first transmission component; one end of the first transmission component close to the synchronization mechanism is disposed with a first slide rail sub-component, and one end of the first transmission component away from the synchronization mechanism is rotatably connected with the first shell; and
a second rotation mechanism fixedly connected with the second shell and arranged on one side of the synchronization mechanism away from the first rotation mechanism; wherein the second rotation mechanism is rotatably connected with the synchronization mechanism, and the second rotation mechanism comprises a second transmission component; one side of the second transmission component close to the synchronization mechanism is disposed with a second slide rail sub-component, and one end of the second transmission component away from the synchronization mechanism is rotatably connected with the second shell;
wherein when the flexible display panel is in an explanate state, the first slide rail sub-component cooperates with the first guide component, and the second slide rail sub-component cooperates with the second guide component; and when the flexible display panel is in a bending state, the first slide rail sub-component is away from the first guide component, and the second slide rail sub-component is away from the second guide component.

2. The foldable display device in claim 1, wherein the synchronization mechanism comprises a first principal axis and a second principal axis, the first rotation mechanism is sleeved on the first principal axis, and the second rotation mechanism is sleeved on the second principal axis;
wherein the first principal axis is rotatably connected with the second principal axis by a gear component.

3. The foldable display device according to claim 2, wherein the gear component comprises a first gear, a second gear, a third gear, and a fourth gear; the first gear is sleeved on the first principal axis, and the second gear is sleeved on the second principal axis;
wherein the third gear is meshed with the first gear, and the fourth gear is meshed with the third gear and the second gear, respectively.

4. The foldable display device according to claim 3, wherein the gear component further comprises a gear fixing bracket, and the gear fixing bracket is provided with a first gear via, a second gear via, a third gear via, and a fourth gear via;
wherein the gear fixing bracket is sleeved on the first principal axis by the first gear via, and the gear fixing bracket is sleeved on the second principal axis by the second gear via; the third gear is fixedly connected with the third gear via in the gear fixing bracket through a first gear protrusion, and the fourth gear is fixedly connected with the fourth gear via in the gear fixing bracket through a second gear protrusion.

5. The foldable display device according to claim 4, wherein the synchronization mechanism further comprises a first slide rail bracket, and the first slide rail bracket is provided with a fifth gear via, a sixth gear via, a seventh gear via, and an eighth gear via;
wherein the first slide rail bracket is sleeved on the first principal axis by the fifth gear via, and the first slide rail bracket is sleeved on the second principal axis by the sixth gear via; the third gear is fixedly connected with the seventh gear via in the first slide rail bracket through the first gear protrusion, and the fourth gear is fixedly connected with the eighth gear via in the first slide rail bracket through the second gear protrusion.

6. The foldable display device according to claim 5, wherein a side of the first transmission component close to the first slide rail bracket is provided with a first slide rail, and a side of the second transmission component close to the first slide rail bracket is provided with a second slide rail;
the first slide rail bracket comprises a first slide rail guide portion close to the first transmission component and a second slide rail guide portion close to the second transmission component;
wherein when the flexible display panel is in the explanate state, the first slide rail cooperates with the first slide rail guide portion, and the second slide rail cooperates with the second slide rail guide portion; when the flexible display panel is in the bending state, the first slide rail is away from the first slide rail guide portion, and the second slide rail is away from the second slide rail guide portion.

7. The foldable display device according to claim 6, wherein the first rotation mechanism further comprises a first fixed component; a first end of the first fixed component is fixedly connected to the first shell, and the first end of the first fixed component is also rotatably connected to a side of the first transmission component away from the first principal axis;
the second rotation mechanism further comprises a second fixed component; a first end of the second fixed component is fixedly connected to the second shell, and the first end of the second fixed component is also rotatably connected to a side of the second transmission component away from the first principal axis.

8. The foldable display device according to claim 7, wherein the first rotation mechanism further comprises a first hinge-typed rotating shaft fixed on the first transmission component, and the first hinge-typed rotating shaft comprises a first sub-hinged rotating shaft disposed close to the first slide rail bracket and a second sub-hinged rotating shaft disposed away from the first slide rail bracket, and the first fixed component is rotatably connected to the first transmission component through the first hinge-typed rotating shaft;
the second rotation mechanism further comprises a second hinge-typed rotating shaft fixed on the second transmission component, and the second hinge-typed rotating shaft comprises a third sub-hinged rotating shaft disposed close to the first slide rail bracket and a fourth sub-hinged rotating shaft disposed away from the first slide rail bracket, and the second fixed component is rotatably connected to the second transmission component through the second hinge-typed rotating shaft.

9. The foldable display device according to claim 7, wherein the first rotation mechanism further comprises a first torsion arm, and a first end of the first torsion arm is rotatably connected to a second end of the first fixed component; the second rotation mechanism further comprises a second torsion arm, and a first end of the second torsion arm is rotatably connected to a second end of the second fixed component;
wherein the first transmission component is sandwiched between the first torsion arm and the first fixed component, and the second transmission component is sandwiched between the second torsion arm and the second fixed component.

10. The foldable display device according to claim 9, wherein the second end of the first fixed component is provided with a first displacement compensation sliding groove and a second displacement compensation sliding groove, and a first sub-slide rail and the first end of the first torsion arm is provided with a second sub-slide rail; the first sub-slide rail is inserted in the first displacement compensation sliding groove, and the second sub-slide rail is inserted in the second displacement compensation sliding groove;
the second end of the second fixed component is provided with a third displacement compensation sliding groove and a fourth displacement compensation sliding groove, and the first end of the second torsion arm is provided with a third sub-slide rail and a fourth sub-slide rail; the third sub-slide rail is inserted in the third displacement compensation sliding groove, and the fourth sub-slide rail is inserted in the fourth displacement compensation sliding groove;
wherein the first displacement compensation sliding groove and the second displacement compensation sliding groove are arranged symmetrically with a symmetry axis of the first transmission component in a short side direction; and the third displacement compensation sliding groove and the fourth displacement compensation sliding groove is symmetrically arranged with the symmetry axis of the first transmission component in the short side direction.

11. The foldable display device according to claim 9, wherein a second end of the first torsion arm is provided with a first sub-cam and a second sub-cam, the first sub-cam and the second sub-cam are symmetrically arranged with a first symmetry axis of the first torsion arm in a short side direction of the first fixed component, and the first sub-cam and the second sub-cam are sleeved on the first principal axis;
a second end of the second torsion arm is provided with a third sub-cam and a fourth sub-cam, the third sub-cam and the fourth sub-cam are symmetrically arranged with a second symmetry axis of the second torsion arm in a short side direction of the second fixed component, and the third sub-cam and the fourth sub-cam are sleeved on the second principal axis.

12. The foldable display device according to claim 11, wherein the synchronization mechanism further comprises a cam component, and the cam component comprises a first cam sub-component and a second cam sub-component; a first end of the first cam sub-component is sleeved on the first principal axis, and a second end of the first cam sub-component is sleeved on the second principal axis; a first end of the second cam sub-component is sleeved on the first principal axis, and a second end of the second cam sub-component is sleeved on the second principal axis;
wherein the first end of the first cam sub-component is engaged with the first sub-cam, and the second end of the first cam sub-component is engaged with the third sub-cam; the first end of the second cam sub-component is engaged with the second sub-cam, and the second end of the second cam sub-component is engaged with the fourth sub-cam.

13. The foldable display device according to claim 12, wherein the synchronization mechanism further comprises a first spring component, and the first spring component is disposed between the first cam sub-component and the gear fixing bracket; and
wherein the first spring component comprises a first spring and a second spring; the first spring is sleeved on the first principal axis, and the second spring is sleeved on the second principal axis.

14. The foldable display device according to claim 13, wherein the synchronization mechanism further comprises a second slide rail bracket and a second spring component; one end of the second slide rail bracket is sleeved on the first principal axis, and another end of the second slide rail bracket is sleeved on the second principal axis; and
wherein the second spring component is disposed between the second cam sub-component and the second slide rail bracket, and the second spring component comprises a third spring and a fourth spring; the third spring is sleeved on the first principal axis, and the fourth spring is sleeved on the second principal axis.

15. The foldable display device according to claim 14, wherein the synchronization mechanism further comprises a lock catch component; the lock catch component is sleeved on the first principal axis and the second principal axis, and the lock catch component is disposed on one side of the second slide rail bracket away from the second spring component; and
wherein the lock catch component comprises a first lock catch and a second lock catch; the first lock catch is threadedly connected to the first principal axis, and the second lock catch is threadedly connected to the second principal axis.

16. The foldable display device according to claim 14, wherein the second slide rail bracket comprises a third slide rail guide portion close to the first transmission component and a fourth slide rail guide portion close to the second transmission component;
one side of the first transmission component close to the second slide rail bracket is disposed with a third slide rail, and one side of the second transmission component close to the second slide rail bracket is disposed with a fourth slide rail;
wherein when the flexible display panel is in the explanate state, the third slide rail cooperates with the third slide rail guide portion, and the fourth slide rail cooperates with the fourth slide rail guide portion; and when the flexible display panel is in the bending state, the third slide rail is away from the third slide rail guide portion, and the fourth slide rail is away from the fourth slide rail guide portion.

17. The foldable display device according to claim 14, wherein the hinge sub-assembly further comprises a lifting mechanism, the lifting mechanism comprises a lifting plate, and the lifting plate is disposed between the first principal axis and the second principal axis and arranged along a length direction of the first principal axis; and
wherein a first end of the lifting plate is movably connected to the first slide rail bracket, and a second end of the lifting plate is movably connected to the second slide rail bracket.

18. The foldable display device according to claim 17, wherein the lifting mechanism further comprises a first paddle component group sleeved on the first principal axis and a second paddle component group sleeved on the second principal axis;
the first paddle component group comprises a first paddle component and a second paddle component; the first paddle component is disposed between the gear fixing bracket and the first spring, and the second paddle component is disposed between the second slide rail bracket and the third spring;
the second paddle component group comprises a third paddle component and a fourth paddle component; the third paddle component is disposed between the gear fixing bracket and the second spring, and the second paddle component is disposed between the second slide rail bracket and the fourth spring;
wherein the first paddle component, the second paddle component, the third paddle component, and the fourth paddle component are all provided with a boss sub-component, and each of the boss sub-component is used to move the lifting plate along a direction perpendicular to a top view of the foldable display device.

19. The foldable display device according to claim 17, wherein the lifting mechanism further comprises a third spring component, and the third spring component comprises a plurality of spring sub-components; the lifting plate is provided with a plurality of raised components along a direction perpendicular to the top view of the foldable display device; and
wherein in the direction perpendicular to the top view of the foldable display device, each of the spring sub-components is sleeved on a corresponding one of the raised components.

20. The foldable display device according to claim 17, wherein when the flexible display panel is in the explanate state, the lifting plate supports a flexible portion; and when the flexible display panel is in the bending state, the lifting plate is away from the flexible portion.
